(19) United States
(12) Patent Application Publication
(10) Pub. No.: US 2010/0250300 A1
(43) Pub. Date: Sep. 30, 2010

(54) METHOD FOR TRANSFORMING AN ENTERPRISE BASED ON LINKAGES AMONG BUSINESS COMPONENTS, BUSINESS PROCESSES AND SERVICES

(75) Inventors: Samuel M. Antoun, Brunswick, OH (US); Ali P. Arsanjani, Fairfield, IA (US); Graham Paul Bate, Gaithersburg, MD (US); Kishore Channabasavaiah, Palatine, IL (US); Shuvanker Ghosh, Tampa, FL (US); Edward H B Giesen, Bilthoven (NL); Thomas Franklin Guinan, Bethesda, MD (US); Raman Harishankar, Blacklick, OH (US); Kerrie Lamont Holley, Montara, CA (US); Jorge L. C. Sanz, Carmel, CA (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 12/411,781

(22) Filed: Mar. 26, 2009

(51) Int. Cl. G06Q 10/00

(52) U.S. Cl. 705/7

(57) ABSTRACT

A business consulting company performs an assessment of a client business enterprise. The assessment includes use of a computer implemented tool for performing business component modeling techniques for creating a heat map. The heat map is used with the tool to form a domain decomposition, form a goal-service modeling structure, and perform an existing asset analysis based to linkages to the heat map. The assessment is delivered to the client company. A service oriented architecture, SOA, solution plan based on the assessment may also be delivered. The consulting company may implement the SOA plan for the client.

### CROSS REFERENCE TO RELATED APPLICATIONS

This application is related to applications Ser. No. ______, filed ______, entitled, A SYSTEM FOR IMPLEMENTING BUSINESS TRANSFORMATION IN AN ENTERPRISE, and Ser. No. ______, filed ______, entitled, BUSSINESS ASSESSMENT METHOD, both of which shall be incorporated herein by reference in their entireties.

### BACKGROUND OF THE INVENTION

1. Field of the Invention

The invention relates to computer implemented methods of assessing a business enterprise for the purpose of transforming the business operations. More specifically, the invention relates to assessing using the techniques of component business modeling and service oriented architecture as implemented on computer tools.

2. Description of the Related Art

Component Business Modeling (CBM) techniques are described by Rackham is US 2005/0203784, filed Mar. 9, 2004, which is herein incorporated by reference in its entirety. Additional CBM techniques are described in US 2005/0246215, filed Jul. 8, 2005, US 2007/0027701, filed Jul. 15, 2005, US 2007/0021993, filed Jul. 23, 2005, US 2007/0038627, filed Aug. 12, 2005, US 2007/0050232, filed Aug. 26, 2005, US 2007/0162482, filed Jan. 10, 2006, US 2007/0174109, filed Mar. 8, 2007, and US 2008/0221940 filed Mar. 8, 2007.

Service Oriented Modeling and Architecture (SOMA) techniques are described by Ang et al in US 2008/0027784, filed Jul. 31, 2006, which is herein incorporated by reference in its entirety. Additional SOMA techniques are also described in US 2008/0126147, filed Jul. 31, 2006, and US 2008/0270201, filed Apr. 30, 2007.

### OBJECTS AND SUMMARY OF THE INVENTION

It is therefore a principal object of the present invention to provide a method of using both SOMA and CBM techniques for assessing a business enterprise in a way which benefits from the combination. The present invention provides linkages between CBM assessment results and SOMA inputs to provide an overall improved enterprise assessment.

These and other objects are attained in accordance with one embodiment of the present invention wherein there is provided a computer implemented process for assessing an enterprise, comprising the steps of; creating a component business modeling heat map for the enterprise using a computer implemented CBM analysis tool, forming a domain decomposition from the heat map by using CBM competencies as domains, CBM components as functional areas, and CBM component activity as functions, forming a goal-service modeling structure from business component objectives and business component KPI's in the heat map, performing an existing asset analysis from a current system overlay and system assessment of the heat maps by generating a business function system matrix therefrom, and delivering the heat map, the domain decomposition, the goal-service modeling, and the existing asset analysis to the enterprise.

### BRIEF DESCRIPTION OF THE SEVERAL VIEWS OF THE DRAWINGS

FIG. 1 is a diagram depicting linkages between component business modeling and service oriented modeling and architecture techniques;

FIGS. 2a and 2b illustrate linkages between CBM assessment and SOMA assessment;

FIG. 3 illustrates linkages between CBM goals and KPI assessments and SOMA goal-service modeling;

FIG. 4 illustrates linkages between a system application overlay and an existing asset analysis SOMA assessment.

### DETAILED DESCRIPTION OF THE INVENTION

As used herein, a service oriented architecture (SOA) shall be taken to mean an architectural framework that takes everyday business applications and breaks these down into individual business functions. The individual business functions are known herein as services.

### Domain Decomposition

SOMA techniques for assessment of an enterprise are described in US 2008/0027784, US 2008/0126147, and US 2008/0270201. A SOMA domain decomposition is formed in the present invention from a CBM heat map for the enterprise. The purpose of this domain decomposition is to partition and decompose the scope of the project from the perspective of functional areas, processes, information, rules, and policies, as well as, the variations and commonality encountered within a domain.

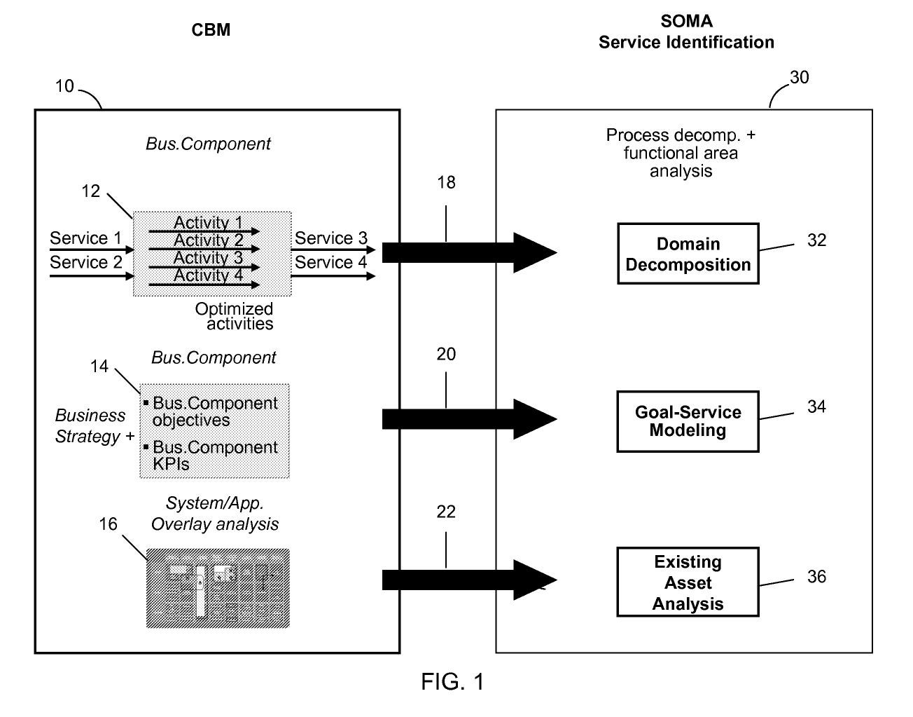

In FIG. 1, there is shown linkage 18, 20, and 22 between a CBM heat map 10 and a SOMA assessment 30 according to the present invention. Linkage 18 shows that CBM competencies are used as SOMA domains, CBM components 12 are used as SOMA functional areas, and CBM component activities within a component 12 are used as SOMA functions, all within a SOMA domain decomposition 32.

Linkage 20 shows that a SOMA goal-service modeling structure 34 is formed from business component objectives 14 and business component by key performance indicators (KPIs) 14. Linkage 22 shows a SOMA existing asset analysis 36 is performed from a CBM current system overlay analysis 16. The heat map 10, domain decomposition 32, goal-service modeling structure 34, and existing asset analysis 36 may all then be delivered to a client company or enterprise, for example, as an assessment performed under a consulting agreement.

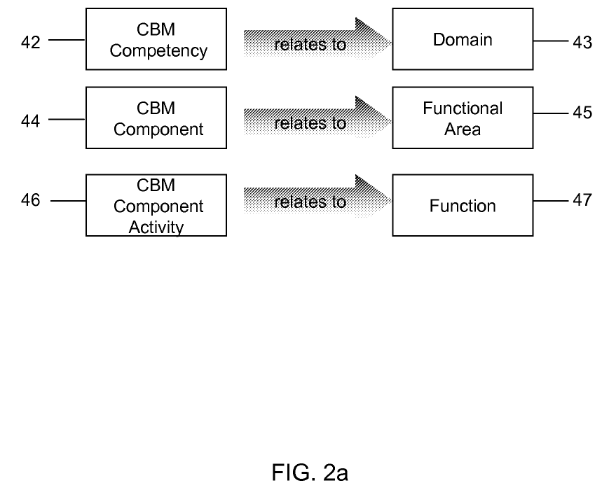

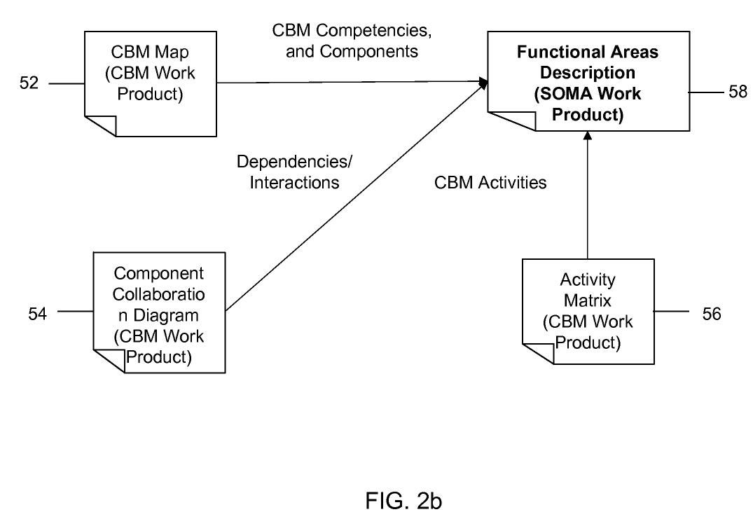

A SOMA domain decomposition assessment includes process modeling and decomposition, functional area analysis, information analysis, rules and policy analysis, and variation oriented analysis. For the present invention, a functional area analysis uses a CBM heat map in the following way. With reference to FIGS. 2a and 2b, CBM competencies 42 from the CBM heat map are treated as domains 43 in the functional area description SOMA work products 58. CBM components 44 from the heat map are treated as functional areas 45 in the functional area description SOMA work product. CBM component activities 46 are treated as functions 47 in the functional area description SOMA work product. This linkage in the present invention between CBM work products 52, 54, 56 to SOMA work product 58 is illustrated in FIG. 2b.

### Goal-Service Modeling

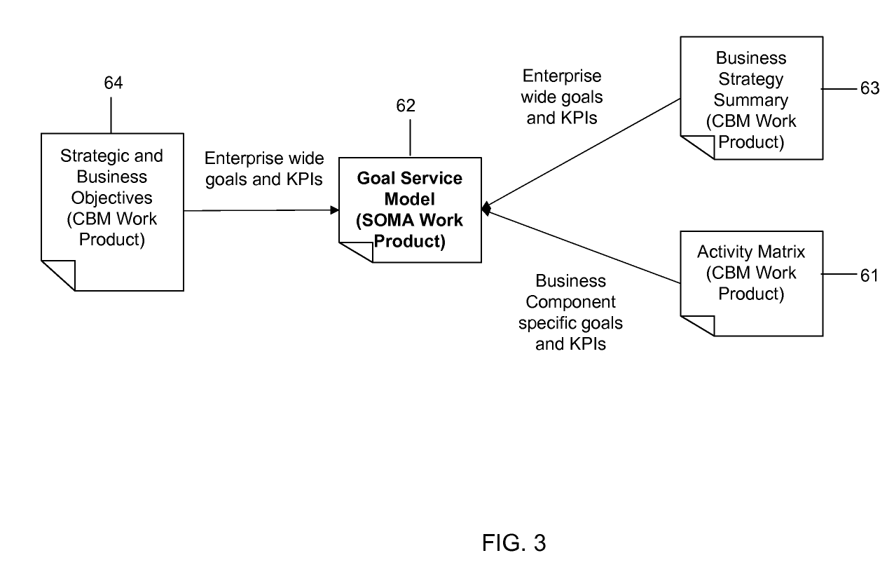

Goal-Service modeling identifies business-aligned services and ensures that important services are not overlooked during domain decomposition or existing asset analysis assessments. In the present invention, business component specific objectives (goals) and KPI's from a CBM heat map activity matrix 61 are used to form a goal-service modeling structure 62 as shown in FIG. 3. Enterprise wide goals and KPI's from strategic and business objectives 64, CBM work product or business strategy summaries 63, may also be optionally used in forming the goal-service modeling structure.

### Existing Asset Analysis

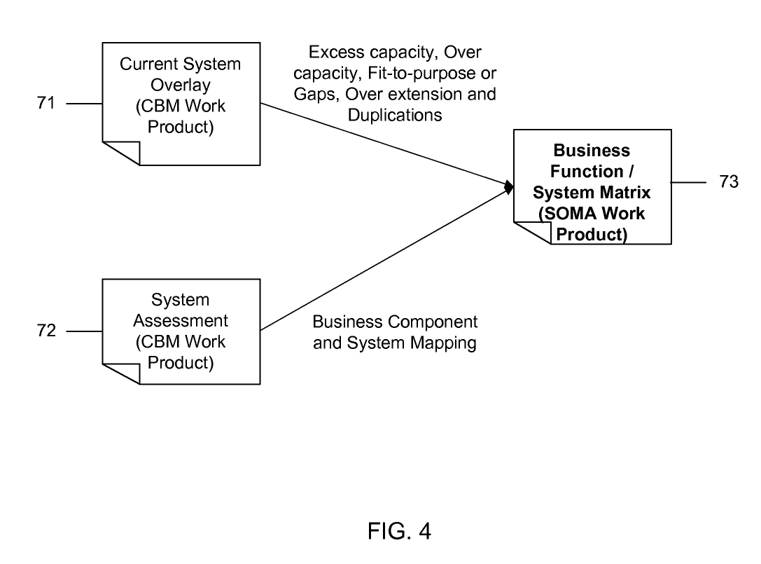

A SOMA business function system matrix 73 is generated from the current system overlay 71 and system assessment 72 of a CBM heat map, as shown in FIG. 4. The present invention uses the heat map in this way to determine the scope of an existing asset analysis.

### Delivery

In a business consulting agreement with a client company for an assessment of their business enterprise, a consulting company, after creating the heat map, forming a domain decomposition, forming a goal-service modeling structure, and performing an existing asset analysis, delivers these to the client company. Delivery may be in the form of hard copy documents printed using a computer implemented tool, such as the tool of related application Ser. No. ______, filed ______, entitled, “A SYSTEM FOR IMPLEMENTING BUSINESS TRANSFORMATION IN AN ENTERPRISE”. The consulting company may also deliver a working copy of the tool to the client company with the heat map, domain decomposition, goal-service modeling structure, and existing asset analysis stored therein.

### SOA Solution

An SOA solution plan may be created from the delivered materials using known SOA techniques. This plan may then also be delivered to the client company. Furthermore, the consulting company may then implement this SOA solution plan for the client company.

While there have been shown and described what are at present considered the preferred embodiments of the invention, it will be obvious to those skilled in the art that various changes and modifications may be made therein without departing from the scope of the invention as defined by the appended claims.

What is claimed is:

1. A computer implemented process for assessing an enterprise, comprising the steps of:
creating a component business modeling heat map for said enterprise using a computer implemented CBM analysis tool;
forming a domain decomposition from said heat map by using CBM competencies as domains, CBM components as functional areas, and CBM component activities as functions;
forming a goal-service modeling structure from business component objectives and business component KPI's in said heat map;
performing an existing asset analysis from a current system overlay and system assessment of said heat map by generating a business function system matrix therefrom; and
delivering said heat map, said domain decomposition, said goal-service modeling structure, and said existing asset analysis to said enterprise.

2. The method of claim 1, further comprising the step of creating an SOA solution plan for said enterprise from said domain decomposition, said goal-service modeling, and said existing asset analysis.

3. The method of claim 3 further comprising the step of delivering said SOA solution plan to said enterprise.

4. The method of claim 3, further comprising the step of implementing said SOA solution plan for said enterprise.

5. The method of claim 1, further comprising the step of delivering to said enterprise a working copy of said computer implemented CBM analysis tool with said heat map stored therein.
